(19) United States
(12) Patent Application Publication
(10) Pub. No.: US 2003/0046420 A1
(43) Pub. Date: Mar. 6, 2003

(54) Media service e-utility

(75) Inventors: Gerd Breiter, Wildberg (DE); Winfried Bruegmann, Altdorf (DE); Peter Taube, Renningen (DE); Hendrik Wagner, Stuttgart (DE)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 10/210,506

(22) Filed: Aug. 1, 2002

(30) Foreign Application Priority Data
Aug. 28, 2001 (EP) 01120448.4

(51) Int. Cl. G06F 15/16

(52) U.S. Cl. 709/237

(57) ABSTRACT

The transmittal of digital information from a customer to a client via the Internet is organized by employing a mediator and a handler. A customer requests the instantiation of a template from a mediator and the creation of necessary infrastructure for all subsequent media is done under the covers. After the instantiation of the template is requested, the mediator receives a message from the customer requesting the registration of digital information. The mediator then makes digital information available to said handler and receives a media key from the handler identifying the digital information. Finally, the mediator sends the media key to the customer. Thus, customers are enabled to use rich media services without the burden previously required by just contacting a media e-utility provider offering media services.

### BACKGROUND OF THE INVENTION

1. Field of the Invention

The present invention generally relates to the distribution of information. Furthermore, it relates to the field of services for media used in environments like the world wide web, in particular, to the way media services are offered and executed. More particularly, the present invention relates to a method and system for organizing the transmittal of digital information from a customer to a client via a distributed information system by employing a mediator and a handler.

2. Description of the Related Art

New media data, e.g., multimedia data, such as streaming audio and video, and a wide variety of new online services are getting more and more pervasive in Internet applications. Such Internet applications using the new media and services have different requirements and uses, but they are all working with similar content data. However, on one hand, the employed content data needs to be composed to work in a common environment, while on the other hand, the variety content data needs to be treated differently, e.g., streaming data requires a higher bandwidth for its transmission, the provision of secure data links demands a fast server computer which is able to perform the encryption/decryption operation, and accounting services which need quick data base access. Due to this fact, Internet applications are becoming more and more complex and are not easily customizable to individual requirements requested by clients, such as individual persons, small companies or big enterprises. Furthermore, rich media services require a very complex infrastructure, e.g., to get acceptable media streaming services a huge amount of distributed servers, so called edge servers, need to be provided. On top, hosting services, distribution and caching services, streaming services, billing services, advertising services and metering services are required as well to enable short access latency time and streaming.

Building up, operating and maintaining of such an infrastructure with 24/7 QOS (Quality Of Service) is very complex and expensive and needs high skilled operation personal. Hence, the entire infrastructure that needs to be provided in order to present rich media in the Internet is quite expensive. For a number of business models such constraints creates unacceptable expenses for the clients that refrains them from using these media offerings.

### SUMMARY OF THE INVENTION

Starting from this, the object of the present invention is to provide a method and a system which enables clients, i.e., individuals and companies, to use new media, such as streaming services, with less effort with regard to the required infrastructure.

The foregoing object is achieved by a method and a system as laid out in the independent claims. Further advantageous embodiments of the present invention are described in the sub claims and are taught in the following description.

According to the present invention a method and a system is provided for organizing the transmittal of digital information from a customer to a client via a distributed information system by employing a mediator and a handler, whereby the mediator is also called media e-utility provider and the handler is called e-service provider. The customer and the client are also referred to as media e-service customer and media e-service client, respectively. A media service e-utility is the combination of one media e-utility provider and a collection of media e-service providers. It defines the interaction between both components and represents one single access point for media related services to the customer.

Initially, the client asks the mediator for a template which is actually a list of services offered. It also contains other parameters for, e.g., Service level agreements, quality of services, banking exchange and other client related data. In response, the mediator returns such a template. Later, the customer sends a selection of services he wants to make use of back to the mediator, which sets up an environment for the particular customer in accordance with the customer's selection, whereby the newly created environment gets identified by an instance key that gets returned to the customer.

From the customer the mediator then receives a message requesting the registration of digital information which he makes available to the handler, whereby the handler takes care of the respective treatment of the digital information. After the handler got the digital information he sends a media key identifying the digital information back to the mediator that forwards it to the customer.

Subsequently, the customer requests digital information by sending the media key and client information to the mediator, whereby the customer sends the request to the mediator as an action caused by a client's request for the digital information. In response, the mediator selects an appropriate handler and forwards the request to the selected handler. The handler in response returns a descriptor back to the mediator to be forwarded via the customer to the client. This descriptor is generated by the handler using the client information to select its most suitable components and then information about the selected components is added to the descriptor. Finally the client uses the descriptor to contact the handler directly to access the services the handler provides.

Typical users of this business process are customers who do not want to spend a lot of money building up and maintaining a media infrastructure required for its service. Either because they need the infrastructure only for a limited period of time or they are not willing to spend the money due to other business constraints.

The business process that may be implemented in accordance with the present invention enables customers to quite easily use rich media services without the burden which is currently involved. They just contact a media e-utility provider (mediator) who offers media services in form of a customizable application template together with all the infrastructure required. The media e-service customer just decides which services he wants to pick up from the portfolio of the media e-utilitiy provider's template, gets the environment and infrastructure for media e-services which is referred to as a media e-utility instance and just uses it, i.e., the media e-services customer requests the digital information identified by the media key, and the necessary processing associated with the media in order to be finally rendered properly on the media e-service clients rendering device (e.g. transcoding, adaptation, streaming etc.).

Advantageously, by applying the concepts of the present invention the media e-service customers are able to reduce the time to market for their rich media Internet applications, since the infrastructure and its administration is handled by the mediator and the handler, respectively.

### BRIEF DESCRIPTION OF THE DRAWINGS

The above, as well as additional objectives, features and advantages of the present invention, will be apparent in the following detailed written description.

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a general block diagram which illustrates a system in accordance with the present invention;

FIG. 2 is a more detailed block diagram of an embodiment of the present invention;

FIG. 3 is a flowchart illustrating a method of instantiating a template in accordance with the present invention;

FIG. 4 is a flowchart illustrating a method of registering digital information in accordance with the present invention; and

FIG. 5 is a flowchart illustrating a method of retrieving digital information in accordance with the present invention.

### DETAILED DESCRIPTION OF THE INVENTION

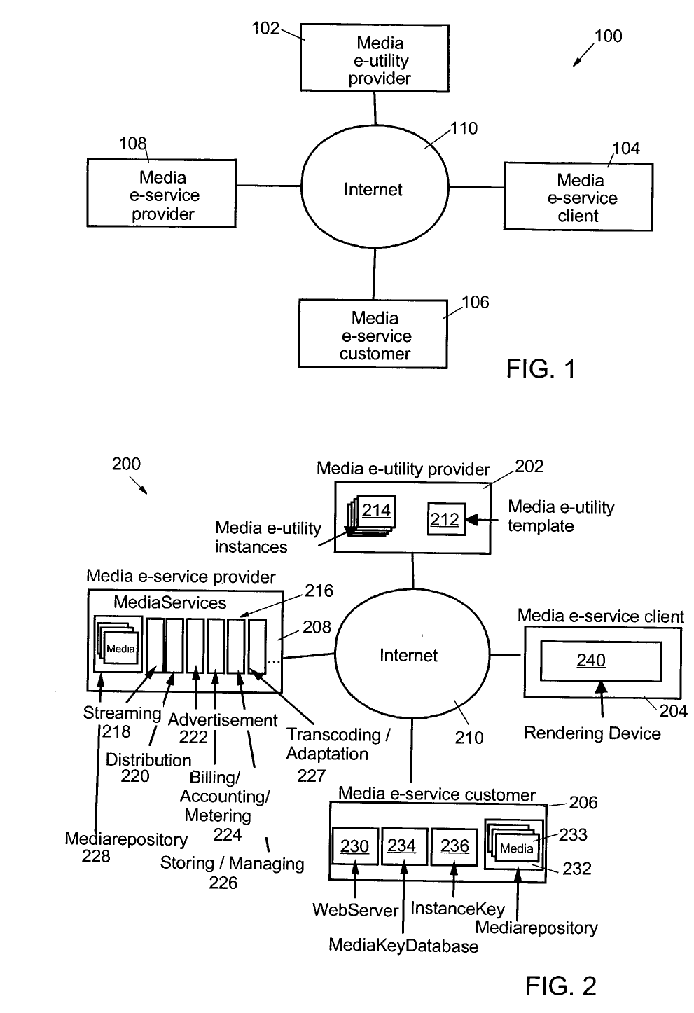

With reference now to FIG. 1, there is depicted a general block diagram which illustrates a system 100 in accordance with the present invention. A media e-utility provider 102 (mediator), a media e-service client 104 (client), a media e-service customer 106 (customer) and a media e-service provider 108 (handler) are all connected to the Internet 110.

The media e-utility provider 102 administrates the media e-service customers, their individual requested services and the respective Service Level Agreements (SLA's). It thereby mediates the services of the media e-services provider to the media e-service customer.

The media e-service provider 108 offers media services, like storing and managing, streaming or metering, to media e-utility providers 102. The media e-service customer 106 uses the media e-utility provider 102 to get media services which he offers his clients, the media e-service clients 104. Hence, the media e-services client 104 uses the media services offered by the media e-utility customer 106. All such players are connected via the Internet 110 and communicate and exchange information in this infrastructure as explained in further detail below. There is explained how the media e-utility provider 102 offers media services to media e-service customers 106 and which interaction between the media e-utility provider 102, the media e-service provider 108, the media e-service client 104 and the media e-service customer 106 is performed, so that the media e-service customer 106 finally can profit from the provided media services and offer them to his media e-service clients 104.

With reference to FIG. 2, there is depicted a more detailed block diagram of an embodiment of the present invention. In short, FIG. 2 shows the components of the players, namely, a media e-utility provider 202, a media e-service client 204, a media e-service customer 206 and a media e-service provider 208, all connected to the Internet 110. The media e-utility provider 202 has got the following components. A media e-utility template 212 which is the electronic form of all the media services and terms and conditions he offers to his media e-utility customers 206. The media e-utility template 212 may be implemented as a XML (Extensible Markup Language) file. These services may either be offered by the media service e-utility provider 202 itself or delegated to dedicated media e-service providers 208. Furthermore, the media e-utility provider has one or more media e-utility instances 214.

A media e-utility instance 214 is the representation of the media services including all the necessary information such as service level agreement and other media e-services customer 206 related information. It may be implemented by using Java classes in accordance with the Java Technology, jar files, i.e., a compressed archive file containing Java class files, JSPs (JavaServer Pages), i.e., a specification for extending the Java Servlet API (Application Programming Interface) to generate dynamic web pages on a web server, or Servlets, i.e., Java programs that run as part of a network service, typically an HTTP (Hypertext Transfer Protocol) server and respond to requests from clients. More precisely, for every customer of the media e-utility provider there exists an media e-utility instance 214 of the media e-utility template 212. This instance represents the common subset of the infrastructure and the respective services the utility provider provides for the respective customer.

The media e-service provider 208 comprises media services 216 which are of value for media e-service customers, such as, media streaming services 218, i.e., services which allow streaming of media to a web client. The streaming services 218 may be realized by employing stream servers such as an IBM Video Charger, a Real Server by RealNetworks, Inc., or a Quicktime stream server by Apple Computers Inc.

Furthermore, the media e-service provider 208 comprises media distribution services 220, i.e., services, which distribute media so that any media requests by clients only requires a minimal bandwidth of respective Internet connections, but instead use caches local to the client. This may be implemented using again IBM WebSphere Edge Server by International Business Machines Corporation. The media e-service provider 208 further includes advertisement services 222, i.e., services which introduce any advertisement information or media during streaming of media or just before or after media streaming, such as banner or animated GIFs (Graphics Interchange Format), and even, billing services 224, i.e., services, which allow clients to bill for any media services, or metering services, i.e., services, which measure usage of media on time level, byte level etc. for any clients and provide this metering information for media service customers, and yet accounting services, i.e., service, which use the data collected via billing and metering to create invoices for any media services. Metering, accounting, billing services and Digital Rights Management Services may be realized by providing an interface to appropriate Internet Applications, such as products from IBM, Portal, Geneva, Intertrust, Liquid Audio, Media Manager by Microsoft Corporation, or Electronic Media Management System (EMMS) from International Business Machines Corporation.

Furthermore Storing and Managing services 226 for the media as well as transcoding and media adaptation services 227 are provided by the media e-service provider 208 which both might be implemented by IBM Enterprise Media Beans. Transcoding also can be provided by IBM Transcoding Publisher. A media repository 228 provided within the media e-service provider 208 handles caching of media and may be implemented by using a file system or any database system.

The media e-service provider 208 may be a different player than the media e-utility provider 202 but both functions may also be performed by the media e-utility provider 202 itself.

The media e-service customer 206 usually comprises a web server 230 to offer web services to it's media e-service clients 204. The web server may be realized by a WebSphere web server by International Business Machines Corporation, an Apache web server by The Apache Software Foundation, or a Weblogic web server by BEA Systems, Inc. for instance.

Additionally, the media e-service customer 206 includes a media repository 232 which contains media 233 in form of digital information, which should be used from its media e-service clients 204, a media key database 234 existing for looking up media keys for media if the media e-service customer wants to access media services 216 for specific media. Furthermore, the media e-service customer 206 includes a media utility instance key 236, which is the result of an instantiate template call and will be used for identification and authorization of the media e-service customer 206 to the media e-utility provider 202 and the media e-service provider 208. The media repository 232 and the media key database 234 may be implemented by using a data base system as DB2 by International Business Machines Corporation, or a data base system by Oracle Corporation or Sybase Inc. The media repository 232 may also be implemented by using an commercial file system or IBM Visual Info by International Business Machines Corporation.

The media e-service client 204 has a rendering device 240 which can include a web browser to access the web site the media e-utility provider 202 offers its services, whereby the web browser may be formed by a Microsoft Internet Explorer or Netscape Navigator browser. Furthermore, the media e-service client 204 includes one or more media player to render any media he accesses via his web browser, such as Quicktime media player by Apple Computers Inc., RealPlayer media player by RealNetworks Inc., or Windows Media Player by Microsoft Inc.. The term Web Browser/Media Player is thereby meant to be used in a generic way, i.e., such components might run on pervasive devices, be combined in one element, and/or only be equipped with fragments of the functionality which is implemented on desktops.

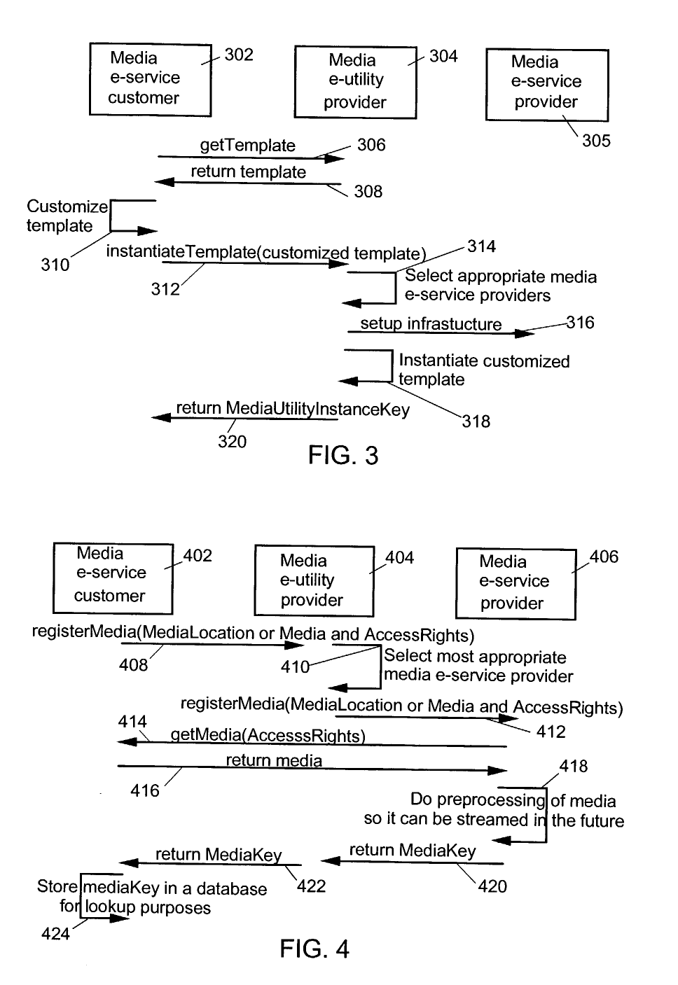

FIG. 3 is a flowchart illustrating a method of instantiating a template in accordance with the present invention. The communication takes place between a media e-service customer 302, a media e-utility provider 304 and a media e-service provider 305. The arrows illustrate the steps of the method including the flow of information.

In case a media e-service customer 302 wants to use media e-services, he looks up a media e-utility provider in a repository, whereby any existing repository may be used. Electronic repositories might be UDDI (Universal Description, Discovery and Integration) or LDAP (Lightweight Directory Access Protocol). Then he contacts the provider he found via a RPC (Remote Procedure Call), SOAP (Simple Object Access Protocol) or any other remote invocation method and asks for a media e-utility template which consists of a list of all media services the media e-utility provider 304 offers, i.e., it's an electronic catalog of all media services available (arrow 306). In return, the media e-utility provider 304 sends the media e-utility template to the media e-service customer 302 (arrow 308).

Then, the customer selects the services he needs (arrow 310) and finally sends back the customized media e-utility template with an instantiateInstance request to the media e-utility provider (arrow 312). The media e-utility provider 304 uses the media e-utility template and processes the request, i.e., first he selects the most appropriate media e-service provider 305 (arrow 314) and forwards the request for creation and setup of an infrastructure and services for the customer to the media e-service provider 305 (arrow 316). This might also include the selection of more than one media e-service provider, e.g., one service provider may be selected for streaming services and another provider may be selected for billing services. Now the media e-utility provider 304 creates a media e-utility instance for the requesting media e-service customer 302 which includes additional media e-service customer 302 administration data (arrow 318). At the end of all the activities an individual infrastructure and environment was created for the media e-services customer 302 and the customer gets a media utility instance key, in order to enable him to identify himself and access media e-services in the future (arrow 320).

With reference now to FIG. 4, there is depicted a flowchart illustrating a method of registering digital information in accordance with the present invention. This time, the communication takes place between a media e-service customer 402 and a media e-utility provider 404 and further involves a media e-service provider 406. Again, the arrows illustrate the steps of the method including the flow of information.

Assuming, the media e-services customer 402 wants to register media to be used in media service requests later on. First, the media e-service customer 402 creates some media and stores it in a dedicated media registry. Then, he contacts the media e-utility provider 404 and authorizes himself with a media utility instance key which he received when registering with the media e-utility provider 404 (cf. FIG. 3). Afterwards, he passes an identification of the location in which the media is stored, e.g., a URL (Uniform Resource Locator) or the media itself, to the media e-utility provider 404 in a so called registerMedia call (arrow 408). In case, the media e-utility provider 404 has got a list of several media e-service providers, he selects a suitable media e-service provider before delegating the request (arrow 410). Then he forwards the register media request to the selected e-service provider 406 (arrow 412), whereby the request contains information about the media location or the media itself and, optionally, information about the access rights.

In case the media has not been passed to the media e-service provider 406 together with the request, the media e-service provider 406 retrieves the media from the passed media location by calling a getMedia call (arrow 414). Optionally this copy step may be deferred until the first getStreamingMedia request is done. Subsequently, the e-service customer 402 returns the requested media (arrow 416) and the media e-service provider performs the preprocessing which is required to use any media services for the passed media (arrow 418).

Then, a media key is passed back to the media e-service customer 402 via the media e-utility provider 404 (arrows 420, 422) which uniquely identifies the media for later media service calls. Finally, the media e-service customer stores the media key in a database for later use (arrow 424).

It is acknowledged that there also exists the inverse service to registerMedia called unregisterMedia, which cleans up any resources needed for a media.

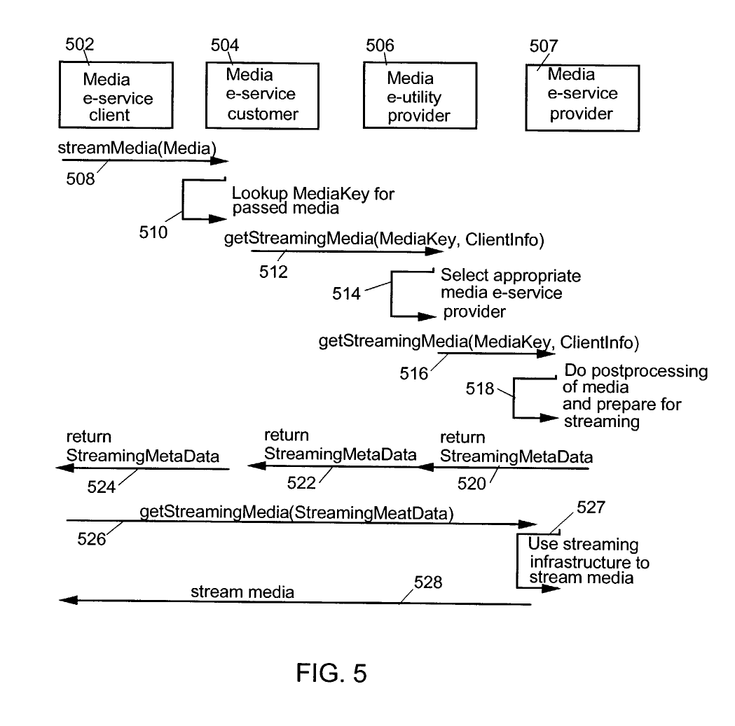

With reference now to FIG. 5, there is depicted a flowchart illustrating a method of retrieving digital information in accordance with the present invention. In this scenario, the communication takes place between a media e-service client 502, a media e-service customer 504, a media e-utility provider 506 and a media e-service provider 507. Whenever a media e-utility customer 504 gets a request from a media e-service client 502 which requires media services (arrow 508), the media e-service customer 504 looks up the media key for the media in its media key database (arrow 510). Subsequently, he contacts the media e-utility provider 506 with his media utility instance key in order to identify himself and invokes the media service he wants to get for the media (arrow 512).

In case, the media e-service customer wishes to initiate streaming of media to the client, then he uses a service like getStreamingMedia providing additional client information in the call. This client information contains information about the locality of the client in the Internet as well as additional information about the client's software and hardware configuration. This information can be used for example by the media e-service provider in the next step to detect the most suitable stream server like depicted in the related patent application “Method and Computer System for Selecting an Edge Server Computer” by G. Breiter et. al, assigned to International Business Machines Corporation, Armonk, N.Y. (US), priority date Apr. 18, 2001 (Assignees Ref. DE9-2001-0005), application number ______, which is incorporated herewith by reference. According to the teaching of said application a mechanism is provided to determine an edge server location to which the client is connected while sending the request for streaming to the application server. This determination is done by adding information to the client's http request containing the media identifier on the way to it's Web application server which is contacted by the client to select a file for downloading and/or streaming.

Next the media e-utility provider 507 selects the most appropriate e-service provider for this request (arrow 514) and forwards this request to the selected media e-service provider (arrow 516). The call of the media e-utility provider 506 will invoke the media e-service provider 507 to post process the requested media and to prepare it for streaming (arrow 518). In this step the media e-service provider generates Streaming Meta Data using the client information to select its most suitable components. Then, information about the selected components is added to the Streaming Meta Data. Afterwards, the media e-service provider 507 returns the Streaming Meta Data to the media e-utility provider 506 (arrow 520). Then, the media e-utility provider 506 returns Streaming Media Data to the media e-service customer 504 (arrow 522), that forwards it to the media e-service client 502 (arrow 524). The Streaming Meta Data includes references to the component of the media e-service provider 506, media classification and additional parameters to control the referred components in the next step.

In response, the media e-service client's rendering device contacts the media e-service provider 307 directly with the Streaming Meta Data in order to get the requested data (arrow 526). In response to the request and after setting up the streaming process (arrow 527), the media e-service provider 507 uses his infrastructure to send the media directly to the media e-service client 502 (arrow 528), e.g., he might use its streaming infrastructure to stream requested media to the media e-service client 502.

The implemented services may either be related to the media itself or media independent services, such as:

getStreamingMedia to request streaming meta media which allows to stream a media on a client media player

getAccountingData to retrieve any accounting data on user base, so the media e-service customer doesn't have to collect accounting data for it's clients. (media independent service where the client id has to be passed)

setAdvertisementRatio to control how much advertisement is included in any streaming of media (media independent service where the client id has to be passed)

setAdvertisementArea, to define the advertisement area which should be used for advertisement

getStreamingMediaHistory to get a history of the media streamed by a user (media independent service where the client id has to be passed)

Advantageously the concepts of the present invention as described above can be employed in a variety of different business applications. It may be used by a media infrastructure provider. This is a company that creates the infrastructure with, e.g., quality & service, caching, streaming, which can be used by media e-utility providers. The services is charged on usage base for the media e-utility provider.

It may be used in the context of film festivals, e.g., The Cannes Film Festival. In such a case, a company might wish to publish on a festival new films created by various movie directors. The jury is a closed group and has to authorize itself to view the films and to grade them. Public audience also can view the films but has to pay for it. Advertisement may be used to reduce the fee for the audience. Furthermore, it may be used in broadcasting, whenever a company located all around the world wants to have a broadcast of its CEO (Chief Executive Officer) to all its employees. The company finds a media e-utility provider via a respective registry, instantiates and deploys a media e-utility template and the broadcast of the CEO is made available to all the companies employees via the media e-services instances.

Another area is distance learning. A university may want to offer online learning services, e.g., online streaming of lectures and tutorials. The customer, i.e., the student, has to authorize himself and during streaming of the lecture billing is done automatically.

Also in promotions the concept can advantageously be applied. E.g., an automobile company just designed a new car and plans to start selling it on a given day. Promotional videos were created and are offered for free on the companies web side. Pre-caching, replication, distribution of the videos is done, so that as soon as the car promotion is started, customers that stream the video are using pre-cached versions of the video automatically. This preloading is done to eliminate bandwidth problems due to the high bandwidth demand for videos.

Another field is video distribution. A movie company no longer wants to sell its films via video cassette. Instead a customer connects to the company's home page, selects a movie, pays for the movie and downloads the movie to its local system either to copy the movie on video cassette or to keep it on the system for future viewing.

Or even the video on demand business. A company wants to send video films via high bandwidth cables to home located customers who have to pay for this offering. They use a special template of an media e-utility provider. Their customers can decide how much advertisement they want to get during the video streaming. More advertisement reduces the fee for the video. When the media e-service customer selects a template with accounting he also is able to create invoices for his customers.

It is acknowledged, that the present invention can be realized in hardware, software, or a combination of hardware and software. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

What is claimed:

1. A method for organizing the transmittal of digital information from a customer to a client via a distributed information system by employing a mediator and a handler, the method comprising the following steps performed by said mediator:
receiving from said customer a message requesting the registration of digital information;
making available said digital information to said handler;
receiving from said handler a media key identifying said digital information; and
sending said media key to said customer.

2. The method according to claim 1, further comprising the steps of:
receiving from said customer said media key and a request for the respective digital information, whereby said customer sends said request in response to a client's request for said digital information;
forwarding a respective request to said handler;
receiving from said handler a descriptor, whereby said descriptor identifies said digital information as being kept by said handler; and
returning said descriptor to said customer to be forwarded to said client.

3. The method according to claim 2, wherein the step of receiving from said customer said media key and a request for the respective digital information further comprises receiving access rights regarding said requested digital information.

4. The method according to claim 3, wherein said descriptor further identifies the methodologies and components of said handler to be used by said handler to enable the proper rendering of said digital information on a client's rendering devices in a subsequent step.

5. The method according to one of the claim 4, wherein the step of receiving from said customer said media key and a request for the respective digital information further includes the step of receiving client information to be used for selecting appropriate methodologies and components of said handler to enable rendering of said digital information on said client's rendering devices.

6. The method according tp one of the claim 5, wherein the step of forwarding a respective request to said handler includes the step of forwarding the client's address to said handler for said handler to prepare said descriptor to identify the components of said handler topologically close to said client to be used by said handler to enable the proper transfering of said digital information with the shortest possible transfering time to the client's rendering devices in a subsequent step.

7. The method according to claim 1 further comprising the initial steps of:
receiving from said customer an inquiry for the services offered by said mediator;
returning a list of services offered;
receiving from said customer a selection of services said client wants to make use of;
setting up an environment for said customer in accordance with the customer's selection identified by an instance key; and
returning said instance key to said customer.

8. The method according to claim 7, wherein the step of setting up an environment for said customer in accordance with the customer's selection identified by an instance key further comprises the steps of:
selecting an appropriate handler; and
inducing said handler to set up an infrastructure for said customer.

9. The method according to claim 8, wherein the step of receiving from said customer a message requesting the registration of digital information includes the step of receiving said instance key identifying the environment set up for said customer.

10. The method according to claim 9, wherein the step of setting up an environment for said customer in accordance with the customer's selection identified by an instance key includes the step of allocating resources to store details about the customer and the customer's selection.

11. The method according to claim 10 wherein the step of making available said digital information to said handler includes the step of getting said digital information from said customer and forwarding it to said handler.

12. The method according to claim 10, wherein the step of making available said digital information to said handler includes the step of receiving location information of the said digital information from said customer and forwarding it to said handler for receiving said digital information from the location identified by said location information.

13. A computer program product stored on a computer usable medium, comprising computer readable program means for causing a computer to perform a method according to claim 12.

14. A system for organizing the transmittal of digital information from a customer to a client via a distributed information system by employing a mediator and a handler, the system comprises:
means for receiving from said customer a message requesting the registration of digital information;
means for making available said digital information to said handler;
means for receiving from said handler a media key identifying said digital information; and
means for sending said media key to said customer.

15. The system according to claim 14, further comprises:
means for receiving from said customer said media key and a request for the respective digital information;
means for forwarding a respective request to said handler;
means for receiving from said handler a descriptor, whereby said descriptor identifies said digital information as being kept by said handler; and
means for returning said descriptor to said customer to be forwarded to said client.

16. The system according to claim 15, wherein said means for receiving from said customer said media key and a request for the respective digital information further comprises means for receiving access rights regarding said requested digital information.

17. The system according to claim 16, wherein said descriptor further identifies the methodologies and components of said handler to be used by said handler to enable the proper rendering of said digital information on a client's rendering devices.

18. The system according to one of the claim 17, wherein said means for receiving from said customer said media key and a request for the respective digital information further include means for receiving client information to be used for selecting appropriate methodologies and components of said handler to enable rendering of said digital information on said client's rendering devices.

19. The system according to one of the claim 18, wherein said means for forwarding a respective request to said handler includes means for forwarding the client's address to said handler for said handler to prepare said descriptor to identify the components of said handler topologically close to said client to be used by said handler to enable the proper transfering of said digital information with the shortest possible transfering time to the client's rendering devices in a subsequent step.

20. The system according to claim 19, further comprising:
means for receiving from said customer an inquiry for the services offered by said mediator;
means for returning a list of services offered;
means for receiving from said customer a selection of services said client wants to make use of;
means for setting up an environment for said customer in accordance with the customer's selection identified by an instance key; and
means for returning said instance key to said customer.

21. The system according to claim 20, wherein said means for setting up an environment for said customer in accordance with the customer's selection identified by an instance key further comprises the steps of:
means for selecting an appropriate handler; and
means for inducing said handler to set up an infrastructure for said customer.

22. The system according to claim 21, wherein said means for receiving from said customer a message requesting the registration of digital information includes means for receiving said instance key identifying the environment set up for said customer.

23. The system according to claim 22, wherein said means for setting up an environment for said customer in accordance with the customer's selection identified by an instance key includes means for allocating resources to store details about the customer and the customer's selection.

24. The system according to claim 23, wherein said means for making available said digital information to said handler includes means for getting said digital information from said customer and forwarding it to said handler.

25. The system according to claim 23, wherein said means for making available said digital information to said handler includes means for receiving location information of the said digital information from said customer and forwarding it to said handler for receiving said digital information from the location identified by said location information.
